(19) United States
(12) Patent Application Publication
(10) Pub. No.: US 2006/0178603 A1
(43) Pub. Date: Aug. 10, 2006

(54) Lumbar adjustable support integrated with massage system

(76) Inventor: Horatiu Mircea Popescu, Sterling Heights, MI (US)

Correspondence Address: Horatiu M. Popescu, 1209 St. Paul Ave., Windsor, ON, N8S 4T6, CA

(21) Appl. No.: 11/394,243

(22) Filed: Mar. 31, 2006

Related U.S. Application Data
(63) Continuation-in-part of application No. 10/969,670, filed on Oct. 21, 2004.

(51) Int. Cl. A61H 23/02

(52) U.S. Cl. 601/93; 601/90; 297/284.4; 601/84

(57) ABSTRACT

Two subassemblies located on the left and right of a seat provided or not with a massage system, each one provided with a bowed arc wire, a straight wire or a molded component, which under the forces exerted by the traction cables on the ends of the arc or on the middle of the straight wires, are respectively arching or relocating, pushing or pulling the back cover or the foam back pad of the seat at the lumbar region of the occupant, generating the lumbar variable pressure.

### CROSS REFERENCE TO RELATED APPLICATIONS

This application is a continuation in part of patent application Ser. No. 10/969,670, filed on Oct. 21, 2004 by the present inventor.

### BACKGROUND OF THE INVENTION

1. Technical field

The present invention generally relates to a lumbar adjustable support and, more specifically, to a simplified mechanism of lumbar support type integrated in the same seat with an adjustable massage system.

2. Prior art

There is currently no device on the market capable of combining the advantage of the adjustable massage system with the ergonomic comfort of the lumbar system. Therefore, the occupant of a seat equipped with any presently available lumbar system can neither use active massage or active lumbar separately, nor active massage and active lumbar in combination. The prior art solutions refer to massage systems only, or to lumbar systems only with their disadvantages.

Previously known solutions for lumbar systems are typically built as flexible structures attached to the seat frame by struts, springs or other flexible elements.

Prior inventions provide many solutions for lumbar systems.

One solution is attaching a small frame with a vertical support wire on each side to a seat structure. An arching subassembly coupled to the wires is adjusted up and down to fit a desired vertical position by sliding along these vertical supports.

The arching subassembly consists of a flexible, plastic lumbar basket and the arching mechanism responsible for its extension. Actuators provide the movements, positioning and extension of the basket.

The solution is not particularly efficient both because the size and number of the components is too large, and the weight and complexity of the mechanisms generating the movement are too great.

Due to the volume and shape of the assembly, the solution prevents mounting a massage system along with the lumbar in the same seat.

Another solution for the lumbar seats consists of a flexible wire support, a plastic arching basket and an actuator. The flexible wire support is made of two thicker vertical wires, and is attached to the seat frame by springs. On this support, thinner wires are mounted horizontally. The plastic arching basket is mounted on these thinner horizontal wires, and the mechanism is mounted directly on the basket.

The solution provided is unsatisfactory due to the width of the assembly, which prevents simultaneously mounting a massage and a lumbar system in the seat. The solution is also flimsy, deflecting backwards proportionally with the state of arching of the basket element and loosing control of the adjustment during the application of the lumbar.

### OBJECTS AND ADVANTAGES

Consequently, a simpler, cheaper, more compact and lighter solution is desirable, with fewer components, such as a bowed arc wire subassembly mounted in the seat on each side of the occupant position.

The present invention, as defined by claims, provides a much lighter solution, and only one bowed arc wire on each side of the seat, pressing with the middle area directly onto the back cover at the level of the lumbar region.

A further aspect of the invention provides adjustment of the active lumbar area to a desired location by moving one or both ends of the bowed arc wires. Due to the position and shape of the active arc wires, as well as the direction of the movement with respect to the load of the occupant's back, the movement of the lumbar is proportional with the adjustment and the deflection is negligible due to the wire-mounting solution.

Another aspect of the invention is the reduced volume occupied by the lumbar system, making it possible to assemble an adjustable massage system along with the lumbar system in the same seat.

Consequently, the advantage of this assembly is to provide the option of using the massage system separately, the lumbar system separately or both the massage and lumbar system simultaneously.

All the above-mentioned features of the present invention, in relation to other concepts, advantages and technical solutions, are easily apparent from the study of the invention's description, claims, and related drawings where they are extensively explained.

### BRIEF DESCRIPTION OF THE DRAWINGS

FIG. 1 shows back isometric assembly view of the, Lumbar adjustable support integrated with the massage system.

FIG. 2a shows the detailed picture of a driving lumbar subassembly.

FIG. 2b shows the wire solutions used by the lumbar system.

FIG. 2c shows a detailed description of the actuator used with the lumbar system.

FIG. 2d shows the detailed picture of a driven lumbar subassembly.

FIG. 2e shows a point symmetry lumbar system.

FIG. 3 shows the details of the cross section 3-3 of the seat with the occupant, cut through the lumbar region.

FIG. 4 shows the basic geometric concept of the bowed arc wire adjustment for the lumbar system.

FIG. 5 shows a first alternative through the lumbar contact area of the bowed arc wires.

FIG. 6 shows a different alternative through the lumbar contact area of the bowed arc wires, with the geometry related to the mechanism generating the lumbar effect.

FIG. 7 shows a palettes-back lumbar support alternative through the lumbar contact area of the bowed arc wires, with the geometry related to the mechanism generating the lumbar effect.

FIG. 8 shows a palettes-no back lumbar support alternative through lumbar contact area of the bowed arc wires, with the geometry related to the mechanism generating the lumbar effect.

FIG. 9 shows a centerline symmetry lumbar system or a 4way lumbar system.

FIG. 10 shows a section 10-10 through a sliding area of the lumbar system.

FIG. 11 shows the driven side of an asymmetrical 2way lumbar system.

FIG. 12 shows a lumbar solution of a general shape of the foam back pad with unattached bask and bowed arc wires.

FIG. 13 shows a lumbar solution of a general shape of the foam back pad with an unattached back cover and straight arc wires.

FIG. 14 shows an isometric section of the lumbar area with foam back pad with unattached back cover and straight arc wires.

FIG. 15 shows a molded alternative solution to the attachment of the traction cable to the back cover side.

FIG. 16 shows a solution to the attachment of the traction cable to the back cover side with an intermediate component.

FIG. 17 shows an attachment solution with holes through the side edges of the back cover.

FIG. 18 shows an attachment solution with extruded J straps sewn to the ends of the back cover.

FIG. 19 shows a transversal section through lumbar area of an imbedded back cover.

FIG. 20 shows a shaped molded connector solution for the back cover end area.

### DETAILED DESCRIPTION OF THE PREFERRED EMBODIMENT

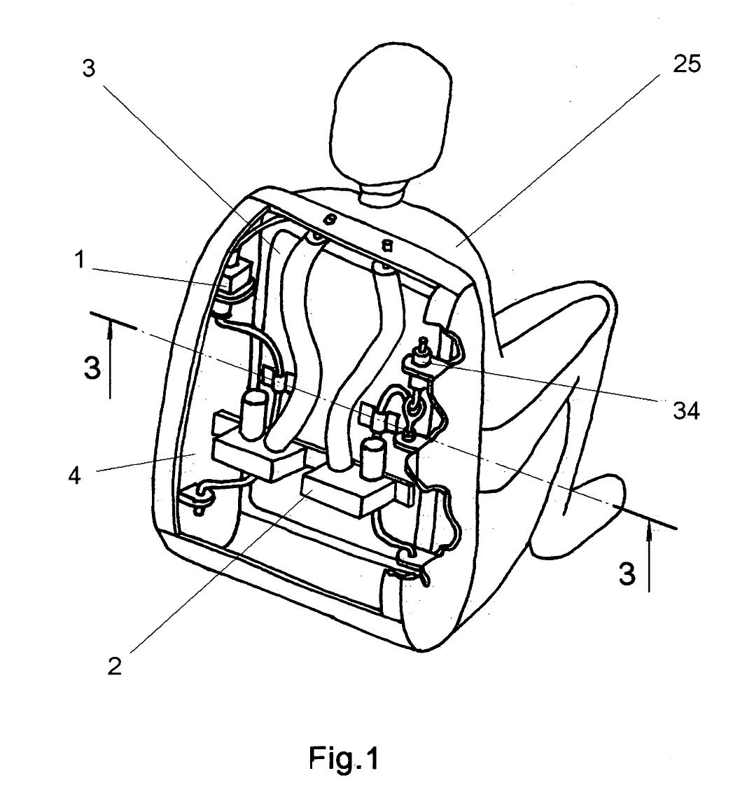

Referring to the drawings, FIG. 1 illustrates an asymmetrical lumbar system, asymmetrical standing for a system with two side devices, and only one side being provided with an actuator. The actuator side is called the driving side, and the opposite side—without an actuator, is called the driven side. An asymmetrical system is also called a 2-way lumbar system.

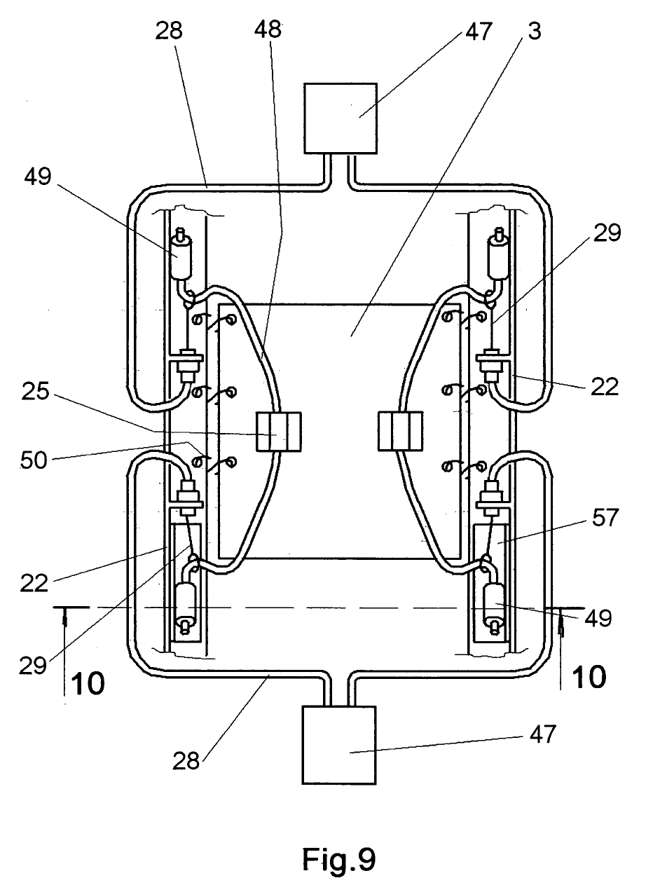

Such a system comprises a driving lumbar subassembly 1, mounted into a seat frame 4 on the left hand side of an adjustable massage system 2, a driven lumbar subassembly 34 mounted on the right hand side of the adjustable massage system 2, and a back cover 3, which is the backing material of the seat-pad, providing support for the seat occupant 35. The springs 50, used to attach the back cover to the seat frame, are visible in FIG. 9.

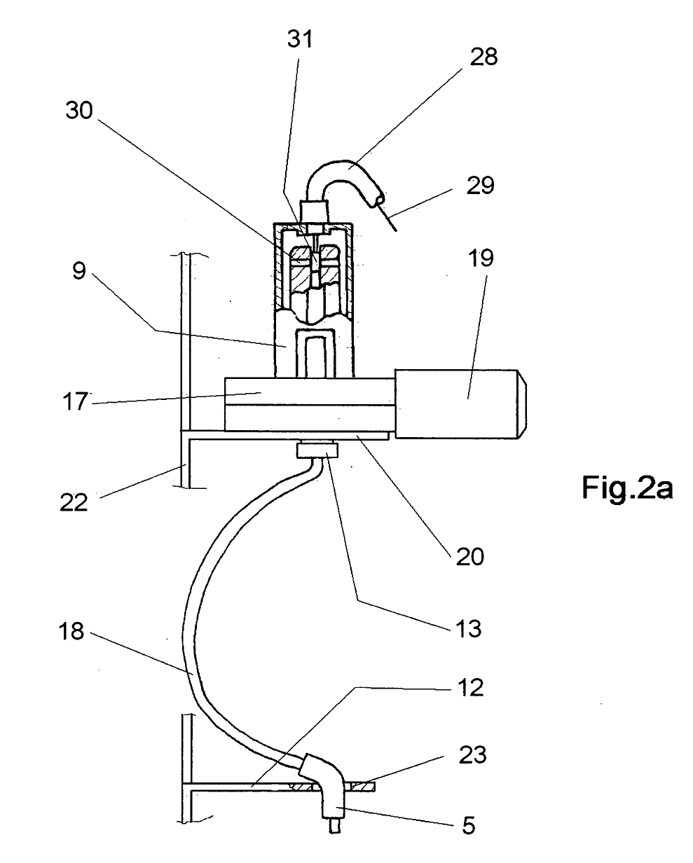

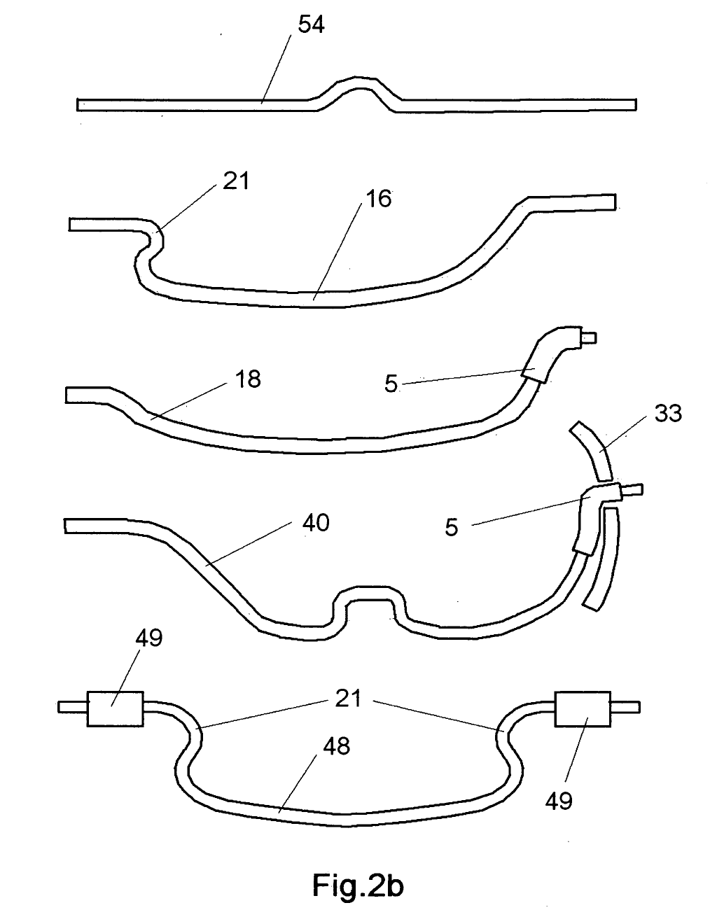

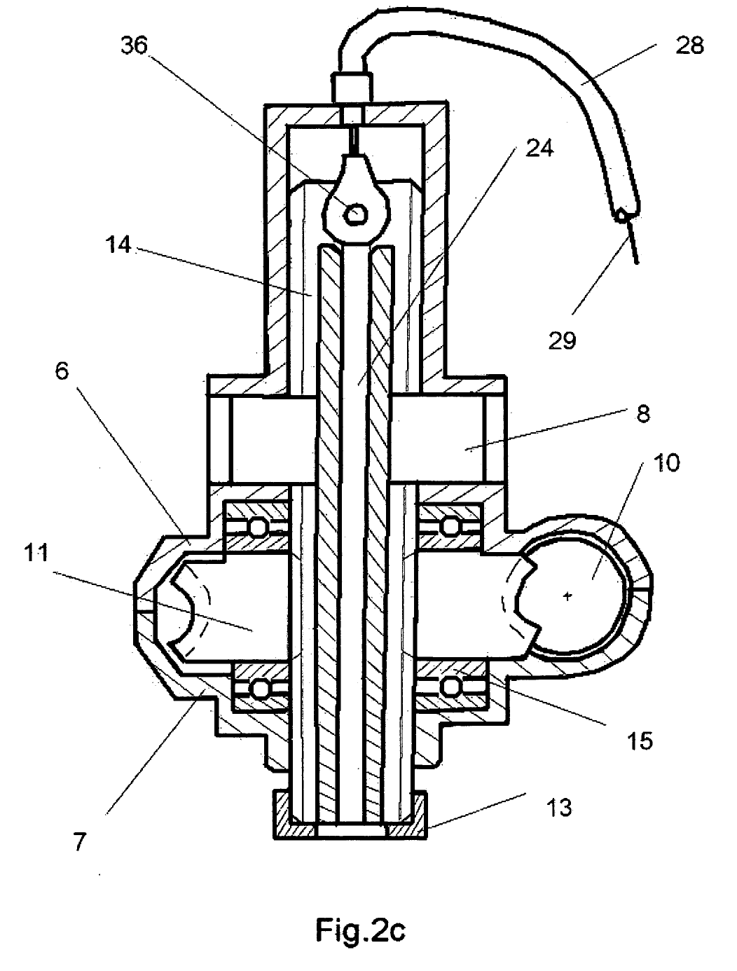

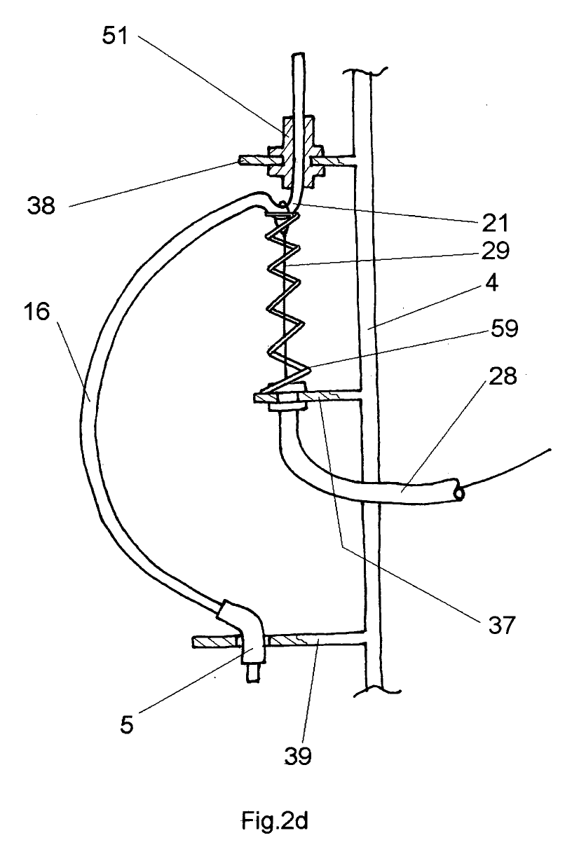

The driving lumbar subassembly 1, illustrated in FIG. 2a, FIG. 2b, FIG. 2c, and FIG. 2d, comprises an electrical motor 19 mounted on an actuator gearbox 17, a bowed arc wire 18, the lower end of which is wrapped in a rubber sleeve 5 and the upper end of which is inserted in a threaded pusher 9, mounted through the gear box 17, and an end cap 13 mounted at the lower end of the pusher 9, see FIG. 2a. There are cases in which the lower part of the seat is occupied by other devices like a power motor for reclining. In this case, in order to facilitate the mounting and avoid cinematic interference, the bowed arc wire 18 can be replaced with a bowed arc wire 40, see FIG. 2b, the lower mounting point of the latter being below the critical area inside the seat. The description of the wire and its functional parts is detailed in the description of FIG. 2b.

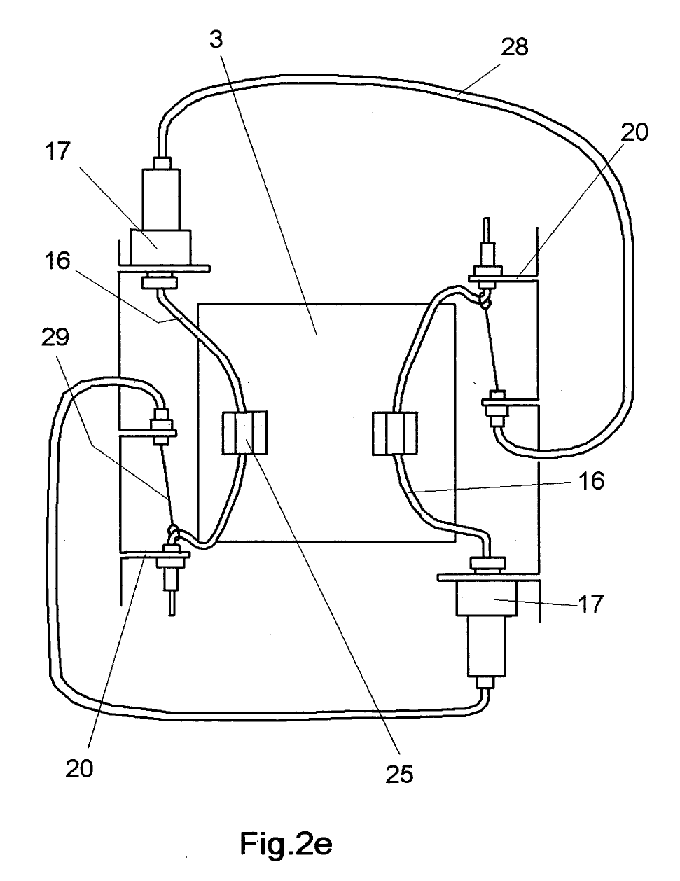

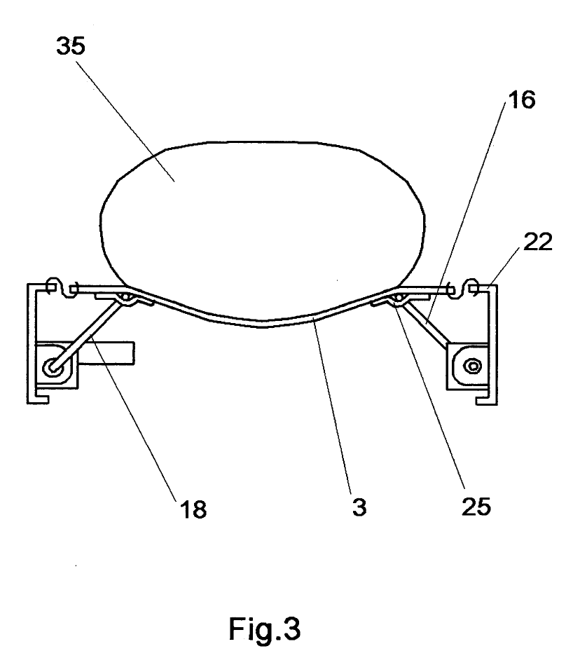

The actuator gearbox 17 is mounted in place on a sidewall 22 of the seat frame 4, which is provided with an upper mounting tab 20 on the upper side of the frame, and another mounting tab 12 on the lower side of the frame. The lower tab 12 is provided with a hole 23 in which a lower part of the bowed arc wire 18 is accommodated. The arching action of the bowed arc wire 18 is applied on the back-cover 3 anchored on the seat frame 4, visible in FIG. 1 and FIG. 3.

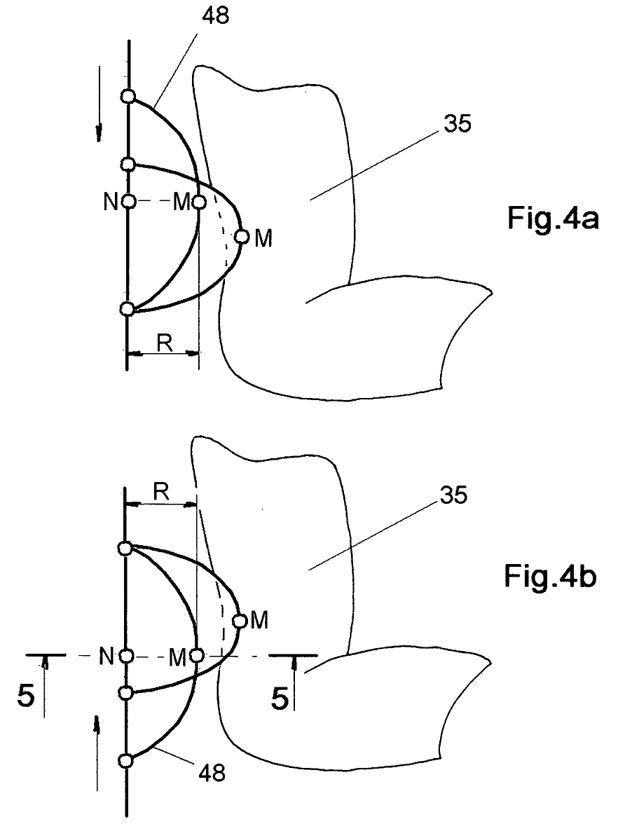

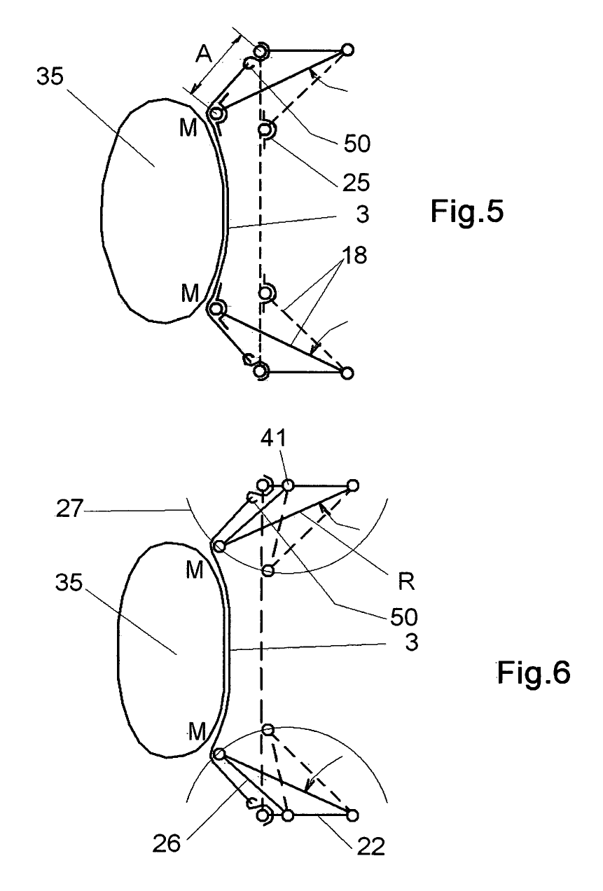

When the lumbar has to be adjusted, the pusher 9 compresses the upper end of the bowed arc wire downwards and, as the wire arches, its middle area pushes the seat back, generating the lumbar effect. Further functional details are explained with the description of FIG. 3, FIG. 4a, FIG. 4b, FIG. 5 and FIG. 6.

The partial section of the upper side of the gearbox 17, visible in FIG. 2a, reveals the construction details of the pusher 9, connected to a Bowden cable 28. A traction cable 29 is coupled to the pusher 9 through a cable loop 31 and an anchor pin 30. The cable duct of the Bowden cable 28 is leaning on a cover extension housing 32, which is part of an upper cover 6 of the gearbox 17, visible in FIG. 2c.

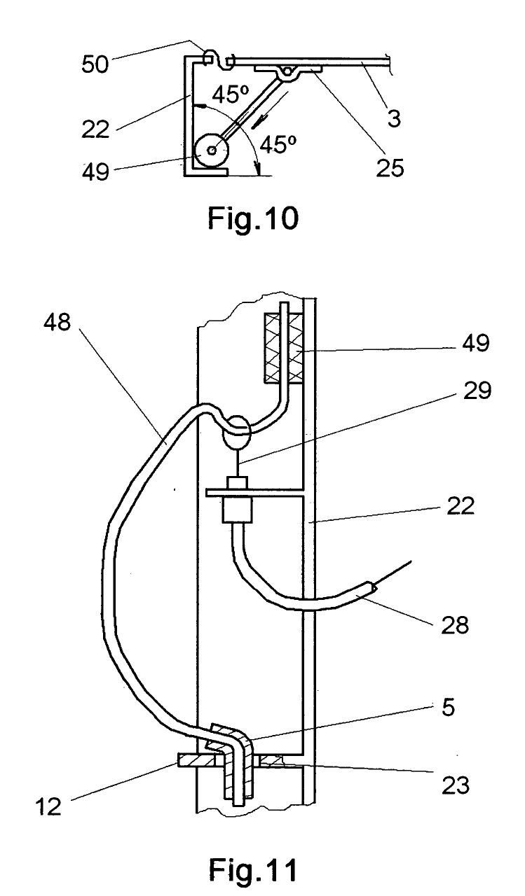

In FIG. 2b, five different versions of wires are presented. A sliding bowed arc wire 48 is depicted, being provided with a wow 21 for the actuator anchor at each end. Each end is also provided with a straight area on which a sliding sleeve 49 is mounted—see FIG. 9 also. The sliding sleeve can be made of felt, canvas type material, composite material, plastic, glass or metal with a low friction coefficient in contact with the frame. The wire mounting and functionality in the lumbar subassemblies is depicted with the description of FIG. 9 and FIG. 10. A bowed arc wire 40 provided with a wow in the middle—to avoid the slippage of anchoring, with a straight area at the top—to be attached to an actuator, and with a bent area at the bottom—to lean on the lower side of the frame, are further depicted. The shape and position of the wow on the wire can vary from seat to seat, depending on structural construction. The lower part of the bowed arc wire 40 is attached to the seat frame on a lower cross-member 33, with the end of the wire protruding through a hole provided and being wrapped in a rubber sleeve 5. The wire mounting and functionality in the lumbar subassemblies are depicted with the description of FIG. 2a.

A bowed arc wire 18 is provided with a straight area at the top, to be inserted in an actuator, and a straight lower area wrapped in a rubber sleeve 5, to be inserted in a frame tab. The wire mounting and functionality in the lumbar subassemblies are depicted with the description of FIG. 2c.

A bowed arc wire 16 is provided with a straight area at the top—to be inserted in a guiding bushing, a wow also at the top—to attach a traction cable, and a straight lower area wrapped in a rubber sleeve 5—to be installed in a frame tab, or straight lower area without rubber sleeve—to be connected directly to an actuator. The wire mounting and functionality in the lumbar subassemblies are depicted with the description of FIG. 2e.

A straight wire 54 is provided with a wow for anchoring a horizontal traction cable. When the wire is straight without wow, the anchor is attached directly on the middle straight area of the wire. The shape of the wow can vary from application to application. I prefer round wows. However, the shape of the wow can be rectangular with round corners, or the wire can have multiple wows to accommodate the anchor shape.

Combinations of the features of these wires are applied to their lower, middle or upper areas to obtain the compound bowed arc wire or the straight arc wire desired for a particular application.

FIG. 2c illustrates a detailed section of the gearbox 17. The pusher 9 is provided with an anchor hole 36 to attach the traction cable 29, and a longitudinal hole 24 along with two side grooves 14, from one end to the other. The upper cover 6 is provided with square side-holes to accommodate a pair of guides 8 sliding along the grooves 14 of the pusher, and preventing the pusher 9 to rotate with respect to the gearbox 17 cover during the process of adjusting.

The pusher 9 is provided with thread on its outside surface, and is threaded into a worm gear 11, traversing the gearbox 17 from the upper cover 6 to a lower cover 7. In order to minimize the friction between the pusher and the covers during rotation, the worm gear 11 is flanked by a trust bearing 15 on each side. A worm 10, coupled to the electrical motor 19, transfers the movement to the worm gear 11 while the thread forces the pusher 9 up and down.

Following the description above, the power generated by the motor 19 is transferred to the worm gear 11 through the worm 10, the threaded center hole of the worm gear 11 is moving the pusher up and down, implicitly with all its attached components, such as the bottom straight-end of the bowed arc wire and the traction cable attached at the top of the pusher.

The upper end of the bowed arc wire 18 or 40, is inserted into the center hole 24 at the bottom of the pusher 9 in order to receive the load of the up and down movement, see FIG. 2a. To avoid the split of the pusher material on the lower area due to the lateral load, the assembly is provided with the end cup 13.

The same amount of movement from the pusher is transmitted through the traction cable 29 of the Bowden cable 28 to the upper side of the bowed arc wire 40 or 18 of the driven lumbar subassembly 34, see FIG. 2d and FIG. 1, at the opposite side of the frame 4, as well as to the upper end of the bowed arc wire 16 of the driving lumbar subassembly 1. In this way, both lumbar subassemblies 1 and 34, with locations visible in FIG. 1, will be equally adjusted, and will move proportionally with the position of the pusher 9 with respect to the worm gear 11.

In FIG. 2d, the driven lumbar subassembly 34 is illustrated.

The traction cable 29 is pulling the upper side of a bowed arc wire with wow 16, sliding the straight portion of the wire through a guiding bushing 51, and compressing a return spring 59 designated to help bring the wire 16 to home position when traction cable 29 is released. The bowed arc wire 16 is provided with a wow 21 to anchor the traction cable 29. The upper end of the Bowden cable duct on the right side of the subassembly is fixed on a tab 37, the bushing guide 51 is fixed on a bushing tab 38, and the lower end of the bowed arc wire with wow 16 is mounted through a tab support 39, being wrapped in the rubber sleeve 5 at the lower end. If the subassembly is mounted without the spring 59, the response to the cable release will be slower.

In FIG. 2e, a point symmetry lumbar system is illustrated, the symmetry standing for a lumbar system in which both sides are provided with actors. The symmetrical lumbar system, also be called a 4-way lumbar system, adjusts both ends of the bowed arc wires 16.

When there is a desire to accommodate occupants within a wide range of stature, the lumbar subassemblies must be able to adjust the height of the protruding center of the bowed arc wires 16 by moving both ends of the wire up or down.

As FIG. 2e depicts, on the left hand side, the actuator 17 moves the upper end of the bowed arc wire 16, the latter being constrained by a left sleeve 25 sewn on the back cover 3. The actuator 17 also moves the upper end of the right bowed arc wire 16 through the Bowden cable 28.

On the right hand side, the actuator 17 moves the lower end of the bowed arc wire 16 constrained by a right sleeve 25 sewn on the back cover 3, and moves the lower end of the left hand bowed arc wire 16 through the Bowden cable 28. In this way, the ends of both arc wires 16 are moving simultaneously and proportionally with the induced adjustment. Further explanation of the concept and possible reasons for moving both ends of the bowed arc wires is given with the description of FIG. 4a and FIG. 4b.

In FIG. 3 illustrates the transversal section 3-3 of the seat in FIG. 1. The bowed arc wires 18 and 16, once bent, extend toward the back cover 3 without changing direction, due to a sleeve 25 sewn on the back cover 3 at this section level on each side of the seat. Because the distances between the sleeves 25 and the closest side of the frame side 22 will remain quasi-invariable due the anchor of the back cover 3 to the frame side 22, the bowed arc wires 18 and 16 will pivot toward the sides of the frame, and in this way, they will stretch the portion of the back cover 3 between the two sleeves 25, pushing forwards the lumbar area of the occupant 35 and inducing the lumbar effect. A further explanation of the functional process of the lumbar is illustrated with the description of the FIG. 4, FIG. 5 and FIG. 6.

FIG. 4a and FIG. 4b describe the concept of a symmetrical lumbar system or a 4 way lumbar system.

In a neutral state of the lumbar subassembly 1 or 34, when the actuators are retracted at their outer position, the middle point M of a bowed arc wire 48, 40, 18 or 16 is defined in neutral position N.

In FIG. 4a, the adjustment of the lumbar for a person of small stature is illustrated. The lumbar area of a small stature occupant 35 will be lower than the neutral position, so the upper side of a bowed arc wire 48, 40, 18 or 16 is adjusted downwards—see the arrow in the picture, generating a movement of the center of the bowed arc wire M below the neutral position N. The lower end of a bowed arc wire 48, 40, 18 or 16 holds its outer position.

In FIG. 4b, the adjustment of the lumbar for a person of large statue is illustrated. The lumbar area of a taller occupant 35 will be higher than the neutral position, so the lower side of a bowed arc wire 48, 40, 18 or 16 is adjusted upwards, generating a movement of the center M of the bowed arc wires 48, 40, 18 or 16 above the neutral position N. In this case, the upper end of the bowed arc wires 48, 40, 18 or 16 holds its outer position.

In FIG. 5, a section through the lumbar contact area of the bowed arc wires 48, 40, 18 or 16 and the back cover 3 is illustrated, bringing further explanation to the concept and functionality of the lumbar device. A sleeve 25 is provided on each side of the back cover 3, at the lumbar level. The bowed arc wires 48, 40, 18 or 16 are mounted through the sleeves 25, in order to prevent the lateral slippage of the contact during the lumbar activity. The sleeves 25 also allow an up and down movement of the bowed arc wires 48, 40, 18 or 16 during the adjustment of the lumbar to the height of the occupant or for pressure adjustment.

The positive contact between the bowed arc wires 48, 40, 18 or 16 and the back cover 3 defines a restrictive lateral distance, identified as A in FIG. 5, between the contact point of the sleeves 25 and the closest anchor point, where the hooks 50 connect the back cover 3 with the frame side 22. The middle portion of the back cover 3 between the contact areas around points M of the two lumbar subassemblies will be stretched and will push the lumbar area forward, generating the lumbar effect. FIG. 5 illustrates the back cover in both states: relaxed—in which case the seat back cover 3 is represented with a straight dotted line, and pushed forward and in contact with the occupants back due to the arching of the bowed arc wires 48, 40, 18 or 16—represented with a solid curved line of three segments. The lumbar effect is generated by the extension of the bowed arc wires 8, 40, 18 or 16 which, under mounting constrains, force the pivoting along the direction of the arrows in the picture.

In FIG. 6, an alternative solution is described. The sleeves 25 are replaced with an anchor 26—flexible but not elastic—attached to the side frame 22 and to the middle area near point M of the bowed arc wires 48, 40, 18 or 16. The bowed arc wires 48, 40, 18 or 16 can also be provided with a wow in the middle—see FIG. 2b, to prevent the slippage of the anchor 26 along the wires during the adjustment.

The radial distance R of the bowed arc wires 48, 40, 18 or 16, between the pivoting axis of the wires and their middle point M, see FIG. 4a, FIG. 4b and FIG. 6, varies with respect to the state of adjustment of the lumbar system. If the bowed arc wires 48, 40, 18 or 16 are arched, the radial distance R increases, but the anchor forces the middle point M to move along the perimeter of a circle 27 with a radius equal to the constant length of the anchor 26. This means the middle points M of the side bowed arc wires 48, 40, 18 or 16 will force the back cover 3 forward—due so the rotation of the bowed arc wires, along the direction of the arrows and around the pivot points 41. The portion of the back cover 3 between middle points M of each of the bowed arc wires 48, 40, 18 or 16 will stretch and move towards the occupant, across the seat back at the level of the lumbar region, generating the lumbar effect or lumbar pressure. The dotted lines represent the position of the system in a neutral state, and the solid lines represent the system in an adjusted state.

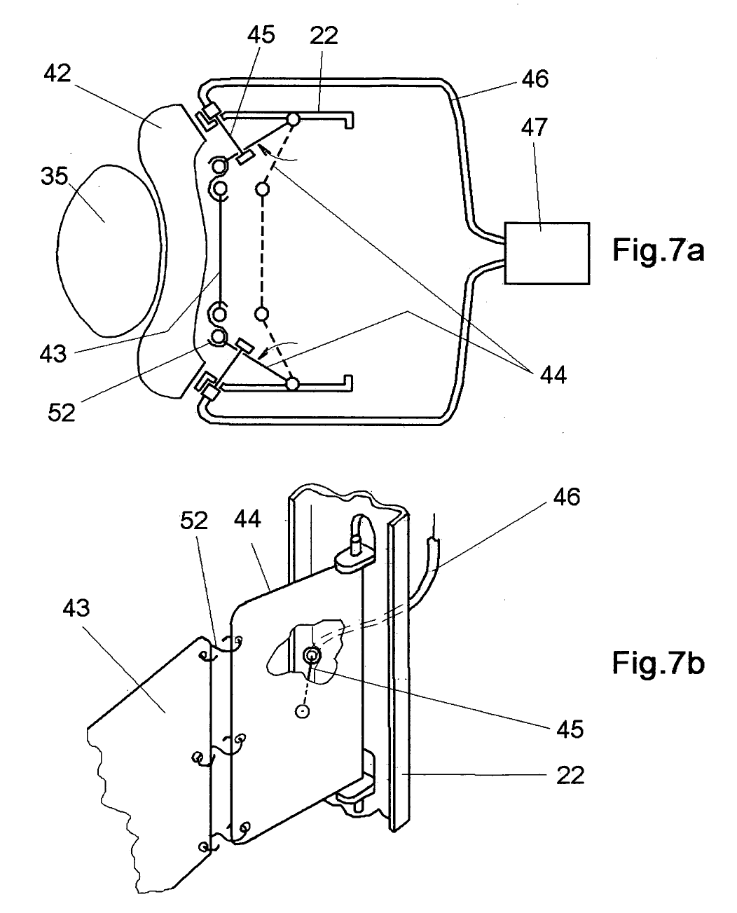

In case the back cover 3 is not provided—see FIG. 7a and FIG. 7b, a back lumbar support 43 will be mounted between the bowed arc wires 48, 40, 18 or 16 at the lumbar height, and the system will work in a way similar to the process described for FIG. 6. The mounting of the back lumbar support 43, made of flexible material with reduced elasticity or no elasticity at all, is further detailed.

In FIG. 7a, a solution for the case when the seat back does not have a back cover is provided. Still the lumbar area of the seat, provided with a foam back pad 42, has to be pushed against the occupant 35 to induce the lumbar effect, and therefore a non-elastic lumbar support strap 43 is mounted between the ends of the side palettes 44, the ends of which are provided with a pivoting axis hinged on each sidewall 22 of the frame 4. The back lumbar support 43 is attached to the palettes 44 by a set of hooks 52 on each side. The palettes are anchored in the middle by a traction cable 45. The cables 45 are part of a Bowden cable 46 on each side of the seat, and they are mounted with one end on the sidewall 22 of the frame 4 and with the other end attached to the actuator 47.

The FIG. 7a depicts the neutral position of the assembly with a dotted line, and the adjusted position of the assembly with a solid line, the movement of the palettes 44 following the direction of the arrows in the picture in order to produce the lumbar effect.

The result of the adjustment is that the back lumbar support 43 is stretched and is pushing the foam back pad 42 against the occupant 35, generating the lumbar effect.

For a better understanding, FIG. 7b represents a partial prospective view of the same assembly described in FIG. 7a.

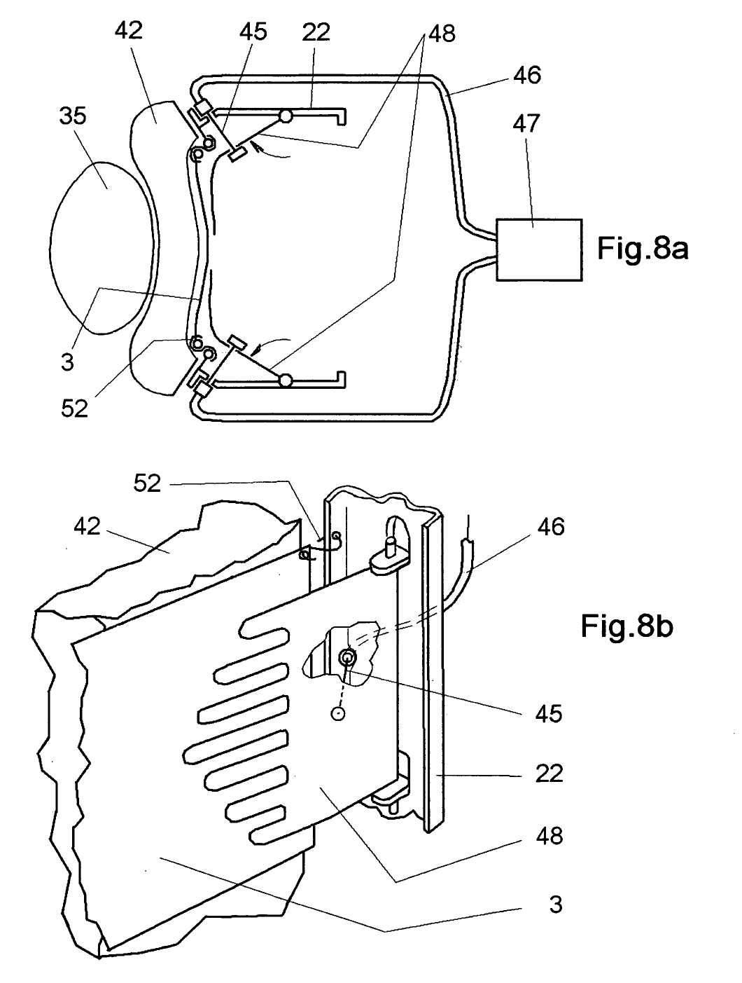

In FIG. 8a, a similar solution to the case in FIG. 7a is depicted, the difference being that the back lumbar support 43 between the palettes 48 is eliminated, the shape of the palettes is changed to improve flexibility, and the back cover 3 is present again in the assembly, being anchored to the sidewalls 22 of the frame 4 by a set of hooks 52. This solution simplifies the mounting process and functions as in the following way: the Bowden cables 46 powered from the same actuator 47, are coupled to the sidewall 22, and the traction cables 45, inserted through a slot provided in each sidewall, are anchored to the side palettes 48. The inner sides of the palettes are very flexible and provided with finger-like extensions. When the cables 45 are pulled, the inner sides of the palettes 48 press against the back cover 3 along the arrows depicted in the figure. The middle portion of the back cover 3 is stretched and pushed forewords pressing the foam back pad 42 against the occupant 35, initiating the lumbar effect.

For a better understanding, FIG. 8b represents a partial prospective view of the same assembly described in FIG. 8a.

In FIG. 9, a centerline symmetry lumbar system is presented. This system has been designed for mounting inside narrow frames, with the side walls 22 constructed in only one piece in order to accommodate the sliding bowed arc wires 48.

For this system, the bowed arc wires 48 are suspended between the loops of the traction cables 29 housed in the Bowden cables 28, with the middle portions of the wires constrained by the sleeves 25 attached to the back cover 3. The back cover in turn is mounted on the sidewalls 22 of the frame 4 with hooks 50. The lower and upper wows of the bowed arc wires 48 are coupled to the same actuator respectively, and are in this way synchronous in their movement. When the upper and lower ends of the bowed arc wires 48, wrapped in sliding sleeves 49, are pulled by the effect of the powered actuators, the wires bend, sliding along the sidewalls 22. Because the middle of the bowed arc wires 48 is constrained by the sleeves 25, the movements of the wires being identical with the description of FIG. 5 and FIG. 6, the lumbar area of the back cover will stretch and the lumbar effect on the back cover 3 will initiate. The difference is that the pivoting axis of the bowed arc wires 48 becomes the centerline of the sleeve-wrapped straight end portions of the wires as they lean against the corners of the sidewalls 22. The lower sides of the bowed arc wires 48, also provided with sliding sleeves, move on a slide support 57 mounted on the inside of the frame walls in order to decrease the friction of the wire ends during the adjustment process. The slide support 57 can be mounted to support all the bowed arc wire ends.

The straight wire ends can also slide on the inside surface of the frame 4 in direct contact with the frame, without using an intermediate component like sliding sleeve 49 or a slide support 57. This solution can be used when the friction coefficient between the wire and the frame is low enough to facilitate the movement of the wire ends during the lumbar adjustment.

FIG. 10 depicts a section 10-10 through a sliding area of the system, and illustrates how the bowed arc wires 48 are contained. Due to the direction of the force indicated by the arrow in the figure and induced by the back cover 3, as well as to the fixed position of the middle wire 48 through the sleeve 25, the ends of the bowed arc wires 48 are contained within the corners of the sidewall stamping 22. The 45° angle between the direction of the arrow and the adjacent walls of the stamping will vary by ±5°. A minimum value angle of 40° will be enough to trap the ends of the bowed arc wires 48 in the inside corner of the sidewall stamping 22. In addition, due to the pretension build at the assembly, by moving the opposite ends of the bowed arc wires 48 toward each other, the ends of the wires 48 will have a permanent and positive contact with the frame corner. The containment condition is maintained whether the inside corner surface of the frame is provided with the slide support 57 or not.

The centerline symmetry system or 4 way system illustrated in FIG. 9 can also be built as a 2 way asymmetrical system as presented in FIG. 11. In this case, the lower side of the bowed arc wire 48 will be provided with a straight portion wrapped in a rubber sleeve 5 and mounted through a hole 23 in a side frame tab 12. The upper end will still have the sliding sleeve 49 and the upper wow attached to the traction cable 29 of the Bowden cable 28. The functioning of the system is similar to the one described for FIG. 9, the difference being that the lower portion of the wire 48 is fixed and only the upper portion is involved in the adjustment process of the: lumbar.

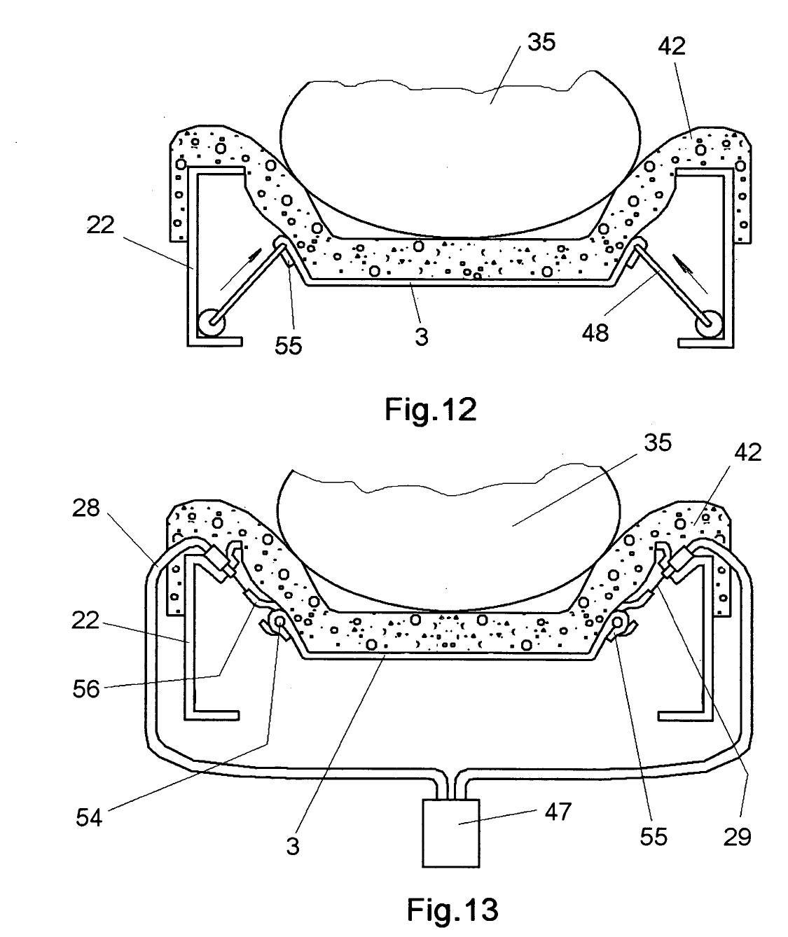

In FIG. 12, the solution described accommodates a foam back pad 42 of a different shape, and a missing contact of the back cover 3 to the sides of the frame. This solution takes advantage of the foam pad's elastic properties.

The bowed arc wires 48 work in a similar way to the solutions previously described for FIG. 9, FIG. 10 and FIG. 11, the difference being that the middle connection between the wires and the back cover 3 is a loop 55 sewn at each side of the back cover as illustrated in the picture. The bowed arc wires deflect under the actuator cable pull and, increasing the radii on the direction of the arrows, they stretch the back cover 3 around the foam back pad and the occupant 35, pushing them forward to generate the lumbar effect. The loops 55 can be replaced with hooks, springs or molded connectors, linking the wires to the back pad 3 by shape to create a flexible attachment.

The foam back pad 42 acts as a reverse spring when the actuators relax, and will bring the bowed arc wires 48 back to home position and ready for an new adjustment.

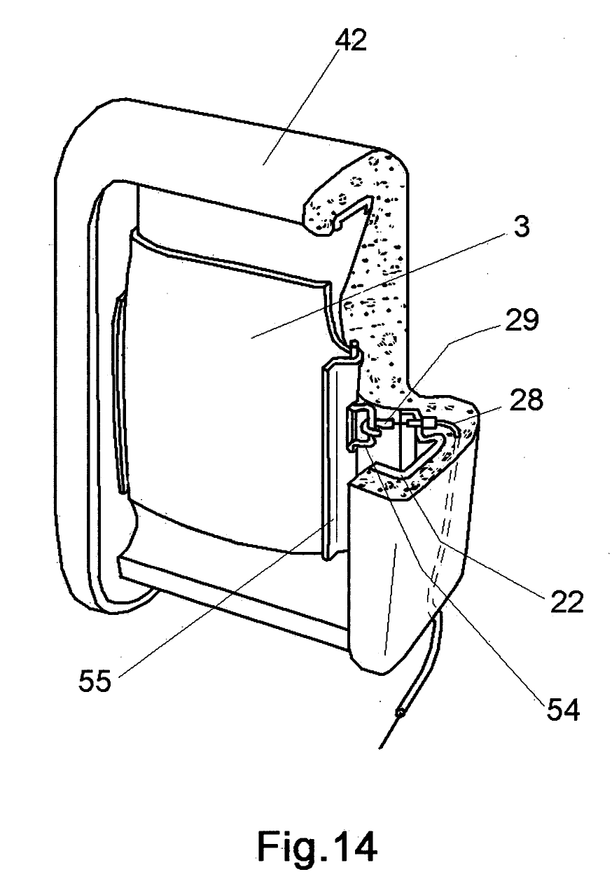

In FIG. 13, the bowed arc wire 48 is replaced with a straight wire 54 whose shape and placement are illustrated in FIG. 2b and FIG. 14. A few alternatives to this solution include a wire 54 without a wow, a wire without a wow and with bent ends to prevent slippage along the loop, and a wire with a sector of a circle with or without wow. The wire 54 can be made of steel, plastic, metal, composite materials, fabric, wood, glass, etc.

Moved by the actuator 47, the traction cables 29 of the Bowden cables 28, anchored on the front area of the frame sides 22, pull the middle of the wires 54 connected through the J hooks 56, and stretch the back cover 3 in the lumbar area through the loops 55, generating the lumbar effect.

FIG. 14 illustrates an isometric section of the lumbar area, showing the placement of the components, described in FIG. 13 with respect to the frame sides 22, and the, position of the loops 55 placed on each side of the back cover 3.

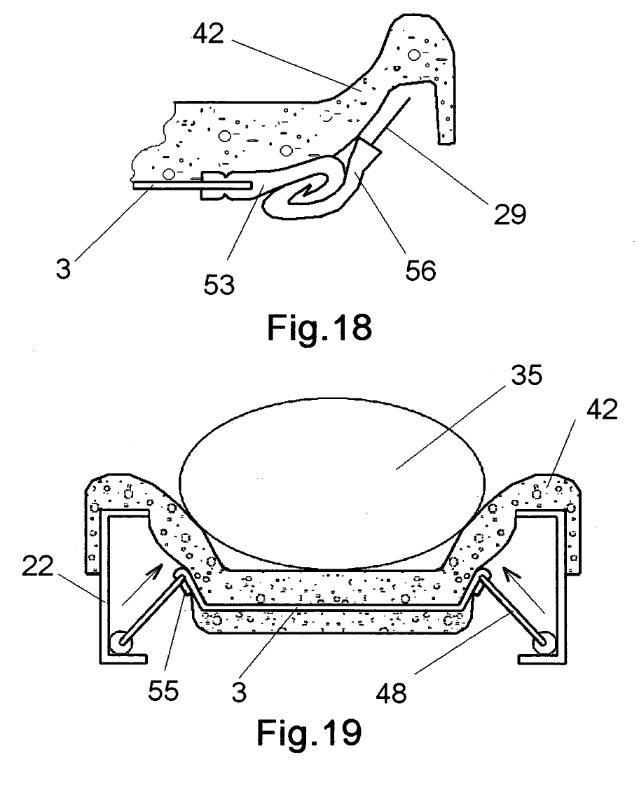

The connection between the traction cable 29 and the back cover 3 can also be achieved by replacing the loops 55 and the wires 54 with components molded directly on the sides of the back cover 3, or by attaching a wire mesh to each end of the back cover 3 and using J hooks molded directly or mechanically attached to the end of the traction cable to connect them by shape. The molded components will be provided with holes, J-hooks, springs, struts, plates, rivets, bolts, tubes, staked components, welded components, or composite material components for attachment. In order to keep the contact between the back cover 3 and the lumbar area of the occupant, the side molded components or wires will have a parabolic geometry oriented toward the occupant and, by simultaneous traction of the side cables 29, will force the back cover to take a saddle shape, see FIG. 20. A different option for J hook connection is exemplified in FIG. 18.

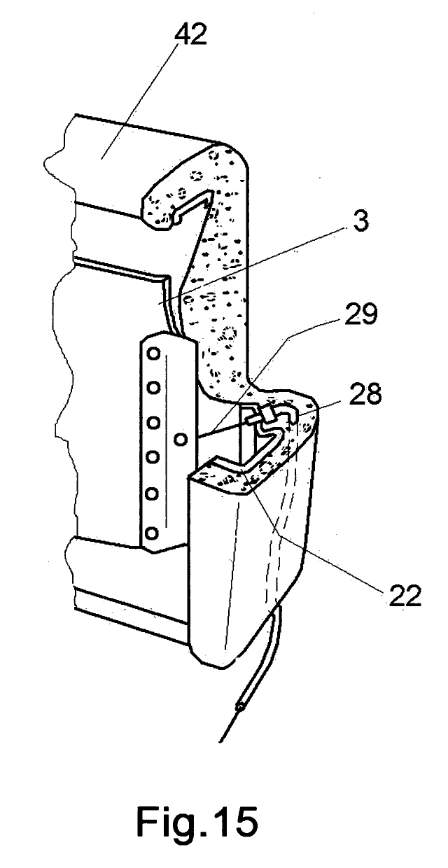

FIG. 15 represents a molded alternative to the connection between the back cover 3 and the ends of the traction cables 29. The back cover subassembly, illustrated in FIG. 15, will be manufactured before molding the foam back pad 42 to back cover 3. The end of the traction cables 29 of the Bowden cables. 28 will be directly connected to the sides of the back cover 3 by molding them together with the end of the back cover.

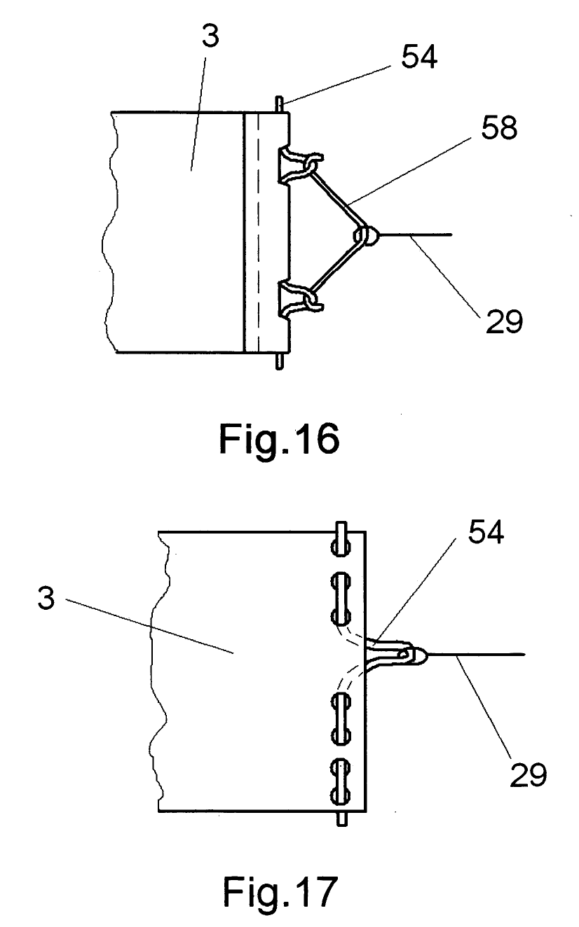

FIG. 16 illustrates an alternative solution to the connection between the back cover 3 and the ends of the traction cables 29, built with an additional intermediate piece 58 made of wire, plastic, tubing, glass, etc. The intermediate piece 58 is anchored at two locations to the wire 54 and mounted on the back cover with a sewn loop. Traction cable 29 is attached to piece 58 in the middle, by rings, hooks, stampings, etc.

In FIG. 17, the wire 54 is inserted through a series of holes pierced through the edge of the back cover 3 before being attached to the traction cable 29.

FIG. 18 shows a transversal section, through the connecting area of the back cover, where an extruded J hook piece 53, as wide as the width of the back cover 3 end, is sewn to the end of the back cover before it is molded together with the pad 42, and is anchored to the traction cable 29 through an other extruded or molded J hook 56, the width of which can vary from a few mm to the width of the back cover. Combinations of the previously described attachments at the end of the back cover or at the end of the traction cable are solutions for a very versatile coupling.

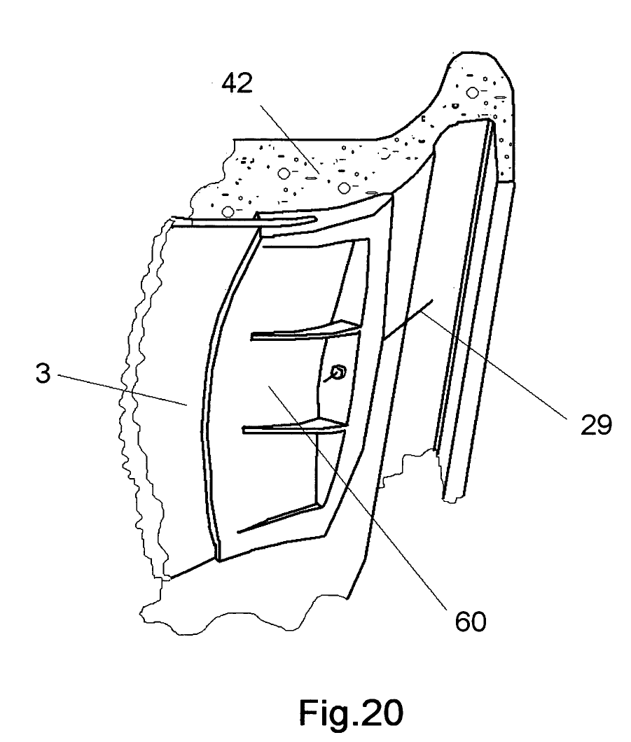

In FIG. 19, another solution is described for the case when the foam back pad 42 has a particular shape, and the back cover 3 is not attached to the side frame, being embedded instead beneath the inside surface of the foam back pad 42. This solution will also take advantage of the foam pad's elastic properties, and offers an alternative to the description of the solution in FIG. 12.

The bowed arc wires 48 work in a similar way to the solutions previously described for FIG. 9, FIG. 10 and FIG. 11, the difference being that the middle connection, between the wires and the back cover 3, is a loop 55 sown at each side end of the back cover, as illustrated in the picture. The bowed arc wires 48 deflect under the actuator cable pull and, increasing the radii on the direction of the arrows, they stretch the back cover 3 around the foam back pad 42 and occupant's body 35 and push them forward, generating the lumbar effect The loops 55 can be replaced with hooks, springs or molded connectors, linking the wires to the back pad 3 by shape and creating a flexible attachment.

The foam back pad 42 is acting as a reverse spring when the actuators relax, and brings the bowed arc wires 48 back to home position and ready for a new adjustment.

The functions of the lumbar and the components of the subassembly are the same as those described with FIG. 12. The back cover can be a wire mesh, a flex-matt, a strap of canvas type material, a molded component, a glass component, a composite component, etc.

In FIG. 20, a molded end connector 60—which inner face is holding the back cover 3 in place giving it a saddle shape, replaces the wire 54 and connects the traction cable: 29 to the back cover 3.

### DRAWING REFRENCE NUMERAL WORKSHEET

1. Driving lumbar subassembly
2. Adjustable massage system
3. Back cover
4. Seat frame
5. Rubber sleeve
6. Upper cover
7. Lower cover
8. Guide (actuator asm)
9. Pusher
10. Worm
11. Worm gear
12. Lower tab support
13. End cap
14. Side grooves
15. Trust bearing
16. Bowed arc wire—with end wow
17. Actuator gearbox
18. Bowed arc wire—no wow
19. Electrical motor
20. Actuator tab support
21. Wow
22. Frame sidewall
23. Hole—locator tab
24. Centre hole—pusher
25. Sleeve—back cover
26. Anchor
27. Circle
28. Bowden cable-single
29. Traction cable
30. Anchor pin
31. End cable loop—upper side actuator
32. Cover extension housing—actuator
33. Lower cross member—frame
34. Driven lumbar subassembly
35. Occupant
36. Anchor hole—pusher
37. End duct tab
38. Bushing tab
39. Tab support
40. Bowed arc wire—with middle wow
41. Anchor pivot
42. Foam back pad
43. Back lumbar support
44. Palette
45. Traction cable
46. Bowden cable-double
47. Actuator
48. Bowed arc wire—sliding
49. Sliding sleeve
50. Hook
51. Guiding bushing
52. Hook
53. Sewn J hook
54. Straight wire
55. Loop
56. J hook
57. Slide support
58. Intermediate anchor
59. Return spring
60. Molded end connector

1. A lumbar system, integrated with a massage system or mounted independently into a seat, comprising:
a distinctive lumbar subassembly unit with a bowed arc wire on each side of the seat
an actuator unit powering the movement of the lumbar subassembly
a Bowden cable unit providing the transfer of the power from the actuator to the lumbar subassemblies
a connecting subassembly to the back cover of the seat
a mounting system to the frame of the seat

2. A lumbar system according to claim 1 wherein said lumbar subassembly comprises:
a bowed arc wire
a rubber sleeve
a sliding sleeve
a slide support

3. A lumbar system according to claim 1 wherein said bowed arc wire is provided with a wow at one or both ends to facilitate the anchoring of the actuator cable. I prefer to form a wow at the end or ends of the bowed arc wire. However, the wow can be substituted by welding the traction cable directly to the end of the wire, by forming a feature on the wire to be connected by shape, by a hole in a flattened area of the wire, by a zipper, by a welded hook, by a welded ring, by a molded component, by a stamped component, by a glass component, by a rubber component, by a textile type component, by a composite component, etc., all allowing the coupling of the traction cable to the bowed arc wire.

4. A lumbar system according to claim 1 wherein said bowed arc wire is provided with a wow in the middle to prevent the slippage of the anchor during the adjustments. I prefer a rectangular shape of the wow with round corners. However, the shape of the wow can vary as it can be replaced with two wows in the middle, one before and one after the area of the connection with the anchor, or without wow, when the anchor is connected directly on the arc of the wire, and is glued to the wire or is coated with rubber, nylon, varnish, paint, etc., to prevent the slippage.

5. A lumbar system according to claim 1 wherein said bowed arc wire is provided with a straight portion at one or both ends to facilitate the mounting of the wire end into an actuator.

6. A lumbar system according to claim 1 wherein said bowed arc wire is provided with a straight portion, at one or both ends, to allow the driven end to slide through a guiding bushing fixed on the side frame of the seat, and having a return spring mounted on the traction cable, between the wire wow and the mounting tab of the traction cable conduit.

7. A lumbar system according to claim 1 wherein said bowed arc wire is provided with a straight or shaped portion at one or both ends, having mounted a sliding sleeve which will provide adjustment by sliding along the inside surface of the seat frame.

8. A lumbar system according to claim 1 wherein said lumbar subassembly is provided with a rubber sleeve, mounted at one or both ends of the said bowed arc wire, to avoid vibrations and noise.

9. A lumbar system according to claim 1 wherein said lumbar subassembly is provided with a sliding sleeve, mounted at one or both ends of the said bowed arc wire, to facilitate the sliding of the ends of the wire along the inside of the seat frame during the adjustment of the lumbar subassembly. I prefer a felt-sliding sleeve. However, the sliding sleeve can be made of canvas type material, composite material, plastic, glass, metal or coated metal, varnish, ceramic, electrolytic coat, aggregated powder or any type of material with a low friction coefficient in contact with the frame surface or frame slide support surface.

10. A lumbar system according to claim 1 wherein said bowed arc wire is provided at one or both ends with a straight or shaped area without a sliding sleeve, to facilitate the sliding of the wire ends directly onto the inside surface of the seat frame.

11. A lumbar system according to claim 1 wherein said bowed arc wire has one or both ends sliding on a slide support mounted on the inside surface of the seat frame to improve the friction coefficient between the bowed arc wire ends and the inside surface of the seat frame. I prefer a plastic molded slide support. However, the slide support can be made of canvas type material, composite material, plastic, glass, metal or coated metal, varnish, ceramic, electrolytic coat, aggregated powder or any type of material with a low friction coefficient in contact with the sliding end of the wire or with the sliding sleeve.

12. A lumbar system according to claim 1, wherein said actuator unit, provided with two driving couplings—a cable coupling and a hole coupling, is also provided with an electrical motor mounted on the cover subassembly and coupled to a worm, flanked on each side by a trust bearing, which is engaged to a worm gear provided with a threaded hole in the center through which a pusher with an outside thread, an end to end center hole and two opposite side grooves is engaged; the pusher slides through the cover subassembly comprising a lower and an upper cover, the latter being provided with a cover extension housing with an end hole, on which leans a Bowden cable conduit, and two opposite side slots through which two guides are mounted and inserted in the side grooves of the pusher, maintaining the orientation of the threaded pusher with respect to the cover subassembly; the traction cable of the Bowden cable, being anchored to the upper end of the pusher by an anchor pin mounted through a hole provided in the pusher, will be pulled or released proportionally with the axial movement of the pusher, whose lower side is covered with an end cup to prevent splitting of the pusher when a bowed arc wire is inserted and driven.

13. A lumbar system according to claim 1 wherein said lumbar subassemblies have asymmetrical structures from left to right and adjust only the upper portion of each side subassemblies, only the driving side being provided with an actuator which is mounted on an upper tab on the driving side of the seat frame and which directly drives the upper straight side of the bowed arc wire inserted into the actuator's pusher hole; the middle of the wire is constrained by a sleeve on the driving side of the seat's back cover and the lower portion of the driving side wire is wrapped in a rubber sleeve and inserted into a tab provided with a hole, the tab being part of the lower frame area; the opposite driven subassembly is provided with a wire whose upper straight area is inserted into a guiding bushing mounted on an upper tab on the driven side of the seat frame; the end of the driven side wire slides in the guiding bushing and is also provided with a wow connected to the traction cable of a Bowden cable, the end of the latter being coupled to the upper portion of the actuator's pusher of the driving subassembly; the middle of the driven bowed arc wire is constrained through a sleeve on the driven side of the seat's back cover and its lower side is wrapped in a rubber sleeve and inserted into a tab provided with a hole, the tab being part of the lower frame area of the seat on the driven side of the system.

14. A lumbar system according to claim 1 wherein said lumbar subassemblies have an asymmetrical structure from left to right and adjust only the lower portion of each side subassemblies, only the driving side being provided with an actuator mounted on a lower tab of the driving side seat frame and directly driving the lower straight side of the bowed arc wire inserted into the actuator's pusher hole; the middle of the wire is constrained by a sleeve on the driving side of the seat's back cover and the upper side of the driving side wire is wrapped in a rubber sleeve and inserted into a tab provided with a hole, the tab being part of the upper frame area; the opposite driven subassembly is provided with a wire whose lower straight area is inserted into a guiding bushing mounted on a lower tab of the seat frame's driven side; the end of the wire on the driven side, also provided with a wow, slides in the guiding bushing and is connected to the traction cable of a Bowden cable, attached to the upper end of the actuator's pusher of the driving subassembly; the wire has its middle constrained through a sleeve on the driven side of the seat's back cover and its upper side wrapped in a rubber sleeve and inserted into a tab provided with a hole, the tab being part of the upper frame area of the seat in the driven side of the system.

15. A lumbar system according to claim 1 wherein said lumbar subassemblies have point symmetry structures from the right side and from the left side of the seat, have the middle of the bowed arc wires constrained through the side sleeves of the back cover, have the driven straight ends of the bowed arc wires adjacent to the wow sliding through a guiding bushing mounted on the side frame, and have the actuators and the driven ends of the opposite Bowden cables mounted on the same frame tabs, with the actuators adjusting the lower and the upper sides of each subassembly respectively; the left subassembly's upper actuator is directly coupled to the upper end of the left bowed arc wire through the pusher hole and indirectly coupled to the upper right bowed arc wire through the Bowden cable, whose driving end is attached to the upper left actuator and whose driven end is coupled to the wow of the upper right bowed arc wire, making synchronous the movements of the upper ends of both right and left bowed arc wires; the right subassembly's lower actuator is coupled directly to the lower end of the right bowed arc wire through the hole of the pusher and coupled indirectly to the lower left bowed arc wire through the Bowden cable, whose driving end is attached to the lower right actuator and whose driven end is coupled to the wow of the lower left bowed arc wire, making synchronous the movements of the lower ends of both right and left bowed arc wires.

16. A lumbar system according to claim 1 wherein said lumbar subassemblies from the right side and from the left side of the seat have center line symmetry structures, have bowed arc wires provided with wows at both ends to anchor the driven side of the traction cable of the Bowden cables, have bowed arc wires provided with straight areas at both ends to mount sliding sleeves for the up and down adjustment of the wire ends along the inside surface of the seat frame, have the middle of both bowed arc wires constrained through back cover sleeves, have an upper actuator through which Bowden cables drive the upper ends of the right and left bowed arc wires, being coupled to their wows respectively, have a lower actuator through which Bowden cables drive the lower ends of the right and left bowed arc wires, coupled to their wows respectively, and have a slide support for the sliding sleeves on the upper and lower sides of each bowed arc wire, mounted on the inside surface of the seat frame at the wire ends level.

17. A lumbar system according to claim 1 wherein said bowed arc wire is mounted on the seat's lumbar subassembly with a constraining back cover sleeve, having its upper and the lower ends anchored to traction cables, these conduits being in turn coupled to the frame tabs, holding the bowed arc wire suspended between the traction cables and leaning with its ends on the inside surface of the frame; the wire ends are constrained to the inside corner of the frame stamping by the tension built into the wire during assembly and by the reaction force of the back cover, a reaction following the direction of the bisector angle of the seat frame's inside corner on which the ends of wire lean.

18. A lumbar system according to claim 1 wherein said connecting subassembly to the seat's back cover is a sleeve on each side of the cover made of a separate piece of material, sewn at a precise location on the back cover, or by folding over the side ends of the back cover and sewing them down to form a loop. I prefer sewn sleeves or loops. However, they can be staked, riveted, hooked, bolted, glued, molded together or attached with fasteners, hooks, extruded J-hooks, zippers, molded components, elastic clips, springs, straight or shaped wires, etc.

19. A lumbar system according to claim 1 wherein said connecting subassembly to the back cover of the seat is a sleeve on each side of the seat made of a separate piece of material and attached to the back cover at a certain location, or a loop at the end of each side of the back cover. I prefer sleeves or loops made of felt type material. However, they can be made of plastic molded materials, metal, rubber,. glass, wood, composite materials, meshed wires, welded subassemblies, hooks, rings, etc.

20. A lumbar system according to claim 1 wherein said connecting subassembly to the back cover of the seat is represented, by a series of holes pierced through the edges of the back cover to accommodate the mounting of a straight or shaped wire or other connectors to be coupled with the traction cables of the lumbar system.

21. A lumbar system according to claim 1 wherein said bowed arc wire is compressed from the top and has a fixed lower end, or is compressed from the bottom and has a fixed upper end, or is compressed from both the top and the bottom simultaneously, with either of these actions increasing the distance between the arc's middle area and the fixed axis of the anchors of the wire ends, transforming vertical movement into horizontal movement.

22. A lumbar system according to claim 1 wherein said bowed arc wire is compressed from the top, with the lower end fixed, for the purpose of lowering the midpoint of the bowed arc wire by moving it forward and downward and adjusting it to a lower lumbar position for the occupant.

23. A lumbar system according to claim 1 wherein said bowed arc wire is compressed from the bottom, with the upper end fixed, with the purpose of elevating the midpoint of the bowed arc by moving it forward and upward and adjusting it to a higher lumbar position for the occupant.

24. A lumbar system according to claim 1 wherein said bowed arc wires of the lumbar subassemblies are constrained by the lateral sleeves of the seat's back cover, the back cover being anchored to each side of the seat's frame and allowing one or both ends of the bowed arc wires to move along a direction representing a cord of an arc wire, or a parallel to a cord of an arc wire, where the direction of the cord represents a hinge around which each bowed arc wire can pivot, increasing the distance between the pivoting axis and the center area of the arc and forcing the sleeves forwards and to the side, due to the anchors of the sleeves to the back cover; the lateral sleeves are anchored indirectly to the sides of the seat frame, stretching the back cover material between them and pushing it against the occupant with variable pressure, proportional to the movement of the end or ends of the bowed arc wires.

25. A lumbar system according to claim 1 wherein said bowed arc wires of the lumbar subassemblies are constrained through a sleeve located at the inner end of a side anchor, attached at the opposite end to the frame side and leaning on the back cover, allowing one or both ends of the bowed arc wires to move along a direction representing a cord of the arc wire, or a parallel to a cord of the arc wire, where the direction of the cord represents a hinge around which each bowed arc wire can pivot; increasing the distance between the pivoting axis and the midpoint of the bowed arc wire, the sleeves are forced forward and to the side, due to the anchors on the frame sides, stretching the back cover material by increasing the perimeter of the back cover between the frame sides and pushing it against the occupant, with variable pressure, proportional to the movement of the end or ends of the bowed arc wires.

26. A lumbar system according to claim 1 wherein said connecting subassembly to the back cover of the seat—represented by sleeves or loops that are part of the back cover edges or attached to the back cover which is not anchored to the sides of the seat frame but is following the side slopes of the foam back pad shape, stretches the back cover area between the connection points of the middle of the bowed arc wires restrained by the loops or sleeves on the side slope areas of the pad and, due to the synchronized forward movement of the center anchored bowed arc wires, pushes the back cover around the foam back pad and the occupant at the lumbar region, generating the lumbar effect.

27. A lumbar system, integrated with a massage system or mounted independently into a seat, comprising:
a distinctive lumbar subassembly unit with a pivoting pallet on each side of the seat
an actuator unit providing power for the movement of the lumbar subassemblies a back lumbar support

28. A lumbar system according to claim 27 wherein said lumbar subassembly has a lateral pivoting palette, the one side of which has a hinge located on the adjacent side frame, and the other side of which is anchored to an elastic, semi-elastic or flexible but non-elastic center-back lumbar support on each side, respectively; a traction cable, mounted through a hole or a slot provided in the front area of the side frame, is coupled to the palette between the hinge and the anchor with the center-back support and has one end of the conduit of the Bowden cable connected to the front of frame, while the other end is mounted to an actuator; the traction cable stretches the center-back lumbar support between the anchors of the two palettes, straightens the contour of the back lumbar support due to the synchronized forces of the traction cables on each side, and pushes the lumbar back support forward against the foam back pad and the occupant lumbar area, generating the lumbar effect.

29. A lumbar system according to claim 27 wherein said back lumbar support is a flex-mat, a wire meshed assembly, a felt type material, a flexible molded component, a canvas type material or a composite type material, and the anchor with the side palettes is represented by shaped hooks or extruded plastic hook straps, zippers, loops, sleeves, molded components, these being connected by shape, or with bolts, rivets, thread, shaped or straight wires or rings, etc.

30. A lumbar system according to claim 27 wherein said lumbar subassembly has a lateral pivoting palette, the one side of which has a hinge located on the adjacent side frame and the other side of which is free and provided with flexible finger-like tabs of different lengths that lean against the back cover and press it forwards toward the occupant; the palette has a traction cable attached to its middle area, penetrating the adjacent side frame through a hole or a slot provided, with one end of the traction cable conduit coupled to the front area of the side frame and the other end coupled to the common actuator; the traction cable stretches the perimeter of the back cover anchored to the frame sides between the flexible fingers of the palettes through the synchronized pivoting of the latter toward the outside of the seat, generating the lumbar effect.

31. A lumbar system according to claim 27 wherein said pivoting palette is made of metal, wood, meshed wires, shaped wires, molded materials, composite materials, glass, reinforced textile, and its provided fingers slide along the back cover during the process of adjustment. I prefer sliding of the palette end on the back cover. However, the free end of the palette, in particular the fingers, can be provided at the very end with rollers, lined on the back cover side with low friction materials, metal tips, paper, varnish, glass, molded tips, etc.

32. A lumbar system integrated with a massage system or mounted independently into a seat, comprising:
a distinctive lumbar subassembly unit with side connection to the back cover
an actuator unit providing power for both lumbar subassemblies
a back cover support connected to the side lumbar subassemblies

33. A lumbar system according to claim 32 wherein said back cover support is represented by a back cover, molded together with the back pad of the seat, the lateral sides of the cover being bent back and sewn to create a loop in which a straight wire with a wow is inserted and a traction cable is mounted through a hole or a slot provided in the front of the side frame and is attached to the wow by a hook; the back cover is stretched by the simultaneous pull of the traction cables which straighten it and pushing it forwards against the foam back pad and occupant, generating the lumbar effect.

34. A lumbar system according to claim 32 wherein said connection is represented by a straight or shaped wire made of plastic, ferrous or non-ferrous metal, composite material, fabric, wood, glass, molded material, meshed wires, etc., coupled to the traction cable with a J-hook. I prefer a J-hook as a connector between the traction cable and the end of the back cover. However, a ring, hook, zipper, molded component, Velcro, composite component, glass component, stamped component, rubber component, extruded hook strip, etc. can replace the J-hook.

35. A lumbar system according to claim 32 wherein said connection is represented by a molded structure built over the edge of the back cover and the end of the side traction cable, a subassembly molded together with the back pad of the seat, or leaning on the back pad of the seat.

36. A lumbar system according to claim 32 wherein said connection is represented by a straight wire with two wows inserted into the edge loop of the back cover, adjusted to fit in the right openings to allow the attachment of an intermediate anchor to be coupled to be straight wire in two places, the intermediate anchor being connected in turn to its respective traction cable on the side of the seat with a ring, loop, hook, zipper, molded component, composite component, glass component, stamped component, rubber component, welding, etc.

37. A lumbar system according to claim 32 wherein said connection is represented by an extruded hook strap sewn along the both side edges of the back cover and coupled to a J-hook, molded hook, formed wire, welded wire subassembly, exuded hook strap, rubber component, glass component, stamped component, composite component, molded component, etc., which is the end part of the traction cable on that side of the seat.

38. A lumbar system according to claim 32 wherein said connection is represented by a zipper, with one side of the zipper being sewn at the edge of the back cover and the other side being attached to the traction cable on that side of the seat.

39. A lumbar system according to claim 32 wherein said back cover is embedded in the foam back pad of the seat as a horizontal strap and anchored to the side traction cables. I prefer an embedded back cover made of felt type material. However, the embedded back cover can be a wire mesh, a welded subassembly, a molded component, a horizontal wire set attached to an anchored end wire on each side etc.
